(19) United States
(12) Patent Application Publication
(10) Pub. No.: US 2007/0227399 A1
(43) Pub. Date: Oct. 4, 2007

(54) COMPOSITIONS AND METHODS FOR THE PRESERVATION OF WOOD

(75) Inventor: Ibrahim Abou-Nemeh, Lake St. Louis, MO (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: Novus International Inc., St. Louis, MO (US)

(21) Appl. No.: 11/690,288

(22) Filed: Mar. 23, 2007

Related U.S. Application Data
(60) Provisional application No. 60/788,846, filed on Apr. 3, 2006.

(51) Int. Cl. C09D 5/14; C09D 5/16; B05D 3/00; B05D 1/36; B05D 1/02; B05D 1/28; B05D 1/18

(52) U.S. Cl. 106/15.05; 106/18.34; 427/402; 427/297; 427/421.1; 427/429; 427/440

(57) ABSTRACT

The present invention provides compositions and methods for preserving wood. The compositions generally include at least one metal chelate or metal salt of a hydroxy analog of methionine. The method generally involves contacting wood or a wood material with a wood preservation composition of the invention. The invention also includes wood or wood products treated with a wood preservation composition of the invention.

### CROSS-REFERENCE TO RELATED APPLICATION

This application claims priority to U.S. Provisional Application Ser. No. 60/788,846 filed on Apr. 3, 2006, which is hereby incorporated by reference in its entirety.

### FIELD OF THE INVENTION

The present invention provides compositions and methods for preserving wood. The compositions generally include at least one metal chelate or metal salt of a hydroxy analog of methionine.

### BACKGROUND OF THE INVENTION

Wood is an economical and renewable building resource. Untreated wood, however, is subject to decomposition by insects, microorganisms, fungi, and environmental weather degradation primarily associated with continuous solar ultraviolet exposure, and long-term cyclic rain, snow and heat exposure. As such, wood exposed to any of the foregoing conditions is typically chemically treated to ensure long-term structural performance and protection from its natural and environmental predators.

Commercially available chemical wood preservatives are classified as either oil type or waterborne. The oil-type preservatives fall into two main groups: creosote and creosote solutions, and oil borne preservatives. Oil borne preservatives typically include an active agent, such as pentachlorophenol or copper naphthenate that is dissolved in a non-aqueous carrier. While oil type wood preservatives are effective, they are plagued by several drawbacks. Creosote preservatives, because of their toxic fumes, objectionable odor, and black oily finish, are unsuitable for many applications. Moreover, pentachlorophenol and other active agents in oil borne preservatives are environmentally unfriendly and can cause skin irritation in humans.

A highly effective class of waterborne wood preservative is the chromated-copper-arsenic (CCA) compositions. CCA has been utilized for more than three decades and acts effectively to protect wood from both microbial degradation and from environmental hazards. Although CCA is effective, its arsenate is highly susceptible to leaching into the environment. Because arsenate is toxic to not only the environment, but also humans and other animals, the Environmental Protection Agency banned the use of CAA as a wood preservative in 2004. There is a need, therefore, for alternative wood preservatives that do not present health and environmental concerns, that are not cost prohibitive, and that are effective at relatively low application rates.

### SUMMARY OF THE INVENTION

One aspect of the invention encompasses a waterborne wood preservation composition. The composition typically comprises an aqueous carrier and a metal chelate or a metal salt of a hydroxy analog of methionine.

Another aspect of the invention provides a method for inhibiting microbial deterioration of wood. The method generally comprises contacting the wood with a metal chelate or a metal salt of a hydroxy analog of methionine.

A further aspect of the invention provides wood or wood products having a composition of the invention disposed on or within the wood or wood product.

Other aspects and features of the invention will be in part apparent and in part pointed out hereinafter.

### BRIEF DESCRIPTION OF THE DRAWING

FIG. 1 depicts a bar graph illustrating the efficacy of the test wood preservatives to prevent wood decay by the brown rot fungus, Gloeophyllum trabeum. Presented is the least squares means percent weight loss±standard error. The statistical superscripts are symbols generated by the Duncan routine (R. G. D. Steel et al., Principles and Procedures of Statistics—A Biometrical Approach, 3^{rd} Ed., 1997, McGraw-Hill Series) to determine the statistical significance between treatments. Treatments with the same superscripts (letters) are not significantly different.

FIG. 2 depicts a bar graph illustrating the efficacy of the test wood preservatives to prevent wood decay by the brown rot fungus, Postia placenta. Presented are the least squares means weight loss±standard error. The statistical superscripts were generated by the Duncan routine to determine the statistical significance between treatments. Treatments with the same superscripts (letters) are not significantly different.

### DETAILED DESCRIPTION OF THE INVENTION

Applicant has discovered that compositions having metal salts or metal chelates of hydroxy analogs of methionine are effective wood preservatives. In particular, the compositions are effective for inhibiting microbial deterioration of wood. Wood products such as lumber, plywood, oriented strandboard, cellulose, hemicellulose, lignin, cotton, and paper may be treated with the wood preservative compositions of this invention. The treated materials (including wood, paper, cellulose, cotton, lignin and hemicellulose) are substantially resistant to microbial attack and are thus preserved.

### I. Wood Preservation Compositions

The wood preservations compositions of the invention may include a formulation comprising one active agent or a formulation comprising two or more active agents. For formulations having two or more active agents, typically the composition will have a quinoline compound, as detailed in (a) below, and a metal salt or metal chelate hydroxyl analog of methionine, as detailed in (b) below. For each embodiment, the formulation may include an antioxidant as detailed in (c) below or as otherwise known in the art. For formulations having only one active compound, the composition will generally have a metal salt or metal chelate of a hydroxyl analog of methionine.

(a) Quinoline Compounds

The composition may optionally include a quinoline compound having anti-microbial activity. In an exemplary embodiment, the quinoline compound is also an antioxidant. Typically, the quinoline compound will be a substituted 1,2-dihydroquinoline. Substituted 1,2-dihydroquinoline compounds suitable for use in the invention generally correspond to formula (I):

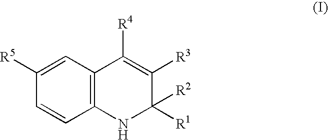

wherein:
R¹, R², R³ and R⁴ are independently selected from the group consisting of hydrogen and an alkyl group having from 1 to about 6 carbons; and
R⁵ is an alkoxy group having from 1 to about 12 carbons.

In another embodiment, the substituted 1,2-dihydroquinoline will have formula (I)

wherein:
R¹, R², R³ and R⁴ are independently selected from the group consisting of hydrogen and an alkyl group having from 1 to about 4 carbons; and
R⁵ is an alkoxy group having from 1 to about 4 carbons.

In one exemplary embodiment, the substituted 1,2-dihydroquinoline will be 6-ethoxy-1,2-dihydro-2,2,4-trimethylquinoline having the formula:

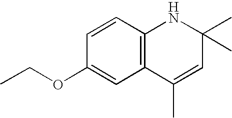

The compound, 6-ethoxy-1,2-dihydro-2,2,4-trimethylquinoline, commonly known as ethoxyquin, is sold under the trademark SANTOQUIN®. The present invention also encompasses salts of ethoxyquin and other compounds having formula (I). Ethoxyquin and other compounds having formula (I) may be purchased commercially from Novus International, Inc. or made in accordance with methods generally known in the art, for example, as detailed in U.S. Pat. No. 4,772,710, which is hereby incorporated by reference in its entirety.

(b) Salts and Metal Chelate Compounds

The wood preservation composition of the invention will typically include a metal salt or a metal chelate of a compound that is effective as an anti-microbial agent when contacted with wood. The compound of the may be a metal salt or a metal chelate of an amino acid or an organic acid. Suitable non-limiting examples of metal ions include zinc ions, copper ions, manganese ions, iron ions, chromium ions, cobalt ions, and calcium ions. Examples of suitable zinc complexes include, but are not limited to, zinc ascorbate, zinc arginate, zinc aspartate, zinc caprylate, zinc cysteinate, zinc ethanolamine phosphate zinc fumarate, zinc glucoheptonate, zinc glutamate, zinc glycerophosphate, zinc glycinate, zinc histidinate, zinc ketoglutarate, zinc malate, zinc methionate, zinc orotate, zinc picolinate, zinc pidolate, zinc succinate, and zinc tartrate. Non-limiting examples of suitable copper complexes include copper adipate, copper ascorbate, copper aspartate, copper citrate, copper fumarate, copper gluconate, copper glutamate, copper glutarate, copper glycinate, copper histidinate, copper ketoglutarate, copper lysinate, copper malate, copper malonate, copper methionate, copper orotate, copper oxalate, copper picolinate, copper sebacate, copper succinate, and copper tyrosinate. Suitable examples of manganese complexes include manganese ascorbate, manganese arginate, manganese aspartate, manganese citrate, manganese cysteinate, manganese ethanolamine phosphate, manganese fumarate, manganese glutarate, manganese glycinate, manganese histidinate manganese lactate, manganese malate, manganese orotate, manganese picolinate, and manganese succinate. Non-limiting examples of suitable iron salts or iron chelates include iron ascorbate, iron arginate, iron aspartate, iron bisglycinate, iron citrate, iron ethanolamine phosphate, iron fumarate, iron glucoheptonate, iron glutarate, iron glycinate sulfate, iron histidinate iron malate, iron orotate, iron pantothenate, iron picolinate, iron pidolate, and iron succinate. Examples of suitable chromium complexes include chromium arginate, chromium aspartate, chromium citrate, chromium ethanolamine phosphate, chromium fumarate, chromium glutamate, chromium glycinate, chromium ketoglutarate, chromium malate, chromium orotate, chromium picolinate, and chromium succinate. Non-limiting examples of suitable cobalt complexes include cobalt arginate, cobalt gluconate, cobalt glycinate, and cobalt malate. Suitable calcium complexes include, but are not limited to, calcium alpha-ketoglutarate, calcium arginate, calcium ascorbate, calcium aspartate, calcium caprylate, calcium citrate malate, calcium cysteinate, calcium ethanolamine phosphate, calcium folinate, calcium formate, calcium fructoheptonate, calcium fumarate, calcium glubionate, calcium glucoheptonate, calcium gluconate, calcium glutarate, calcium glycerophosphate, calcium glycinate, calcium ketoglutarate, calcium lactate, calcium lysinate, calcium malate, calcium methionate, calcium orotate, calcium oxalate, calcium pantothenate, calcium phosphoserine, calcium pidolate, calcium succinate, calcium tartrate, calcium taurate calcium undecyclenate, dicalcium malate, and dihydroxycalcium malate.

In a preferred embodiment, the compound may be a metal salt or a metal chelate of a hydroxyl analog of methionine. In one exemplary embodiment, the hydroxy analog of methionine is a compound having formula (II)

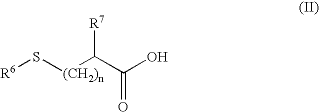

wherein:
n is an integer from 0 to 2;
R⁶ is methyl of ethyl; and
R⁷ is hydroxyl or amino.

In a further exemplary embodiment for compounds having formula (II), n is 2, R⁶ is methyl and R⁷ is hydroxyl. The compound formed by this selection of chemical groups is 2-hydroxy-4(methylthio)butanoic acid (commonly known as “HMTBA” and sold by Novus International, St. Louis, Mo. under the trade name Alimet®). A variety of HMTBA salts, chelates, esters, amides, and oligomers are also suitable for use in the invention. Representative salts of HMTBA, in addition to the ones described below, include the ammonium salt, the stoichiometric and hyperstoichiometric alkaline earth metal salts (e.g., magnesium and calcium), the stoichiometric and hyperstoichiometric alkali metal salts (e.g., lithium, sodium, and potassium), and the stoichiometric and hyperstoichiometric zinc salt. Representative esters of HMTBA include the methyl, ethyl, 2-propyl, butyl, and 3-methylbutyl esters of HMTBA. Representative amides of HMTBA include methylamide, dimethylamide, ethylmethylamide, butylamide, dibutylamide, and butylmethylamide. Representative oligomers of HMTBA include its dimers, trimers, tetramers and oligomers that include a greater number of repeating units.

The hydroxy analog of methionine may be a metal chelate comprising one or more ligand compounds having formula (II) together with one or more metal ions. Irrespective of the embodiment, suitable non-limiting examples of metal ions include zinc ions, copper ions, manganese ions, iron ions, chromium ions, cobalt ions, and calcium ions. In one embodiment, the metal ion is divalent. Examples of divalent metal ions (i.e., ions having a net charge of 2⁺) include copper ions, manganese ions, calcium ions, cobalt ions and iron ions. In another embodiment, the metal ion is zinc. In still another embodiment, the metal ion is manganese. In an exemplary embodiment, the metal ion is copper. In each embodiment, the ligand compound having formula (II) is preferably HMTBA. In one exemplary embodiment, the metal chelate is HMTBA-Cu, known as copper bis(2-hydroxy-4-methylthio)butanoic acid.

As will be appreciated by a skilled artisan, the ratio of ligands to metal ions forming a metal chelate compound can and will vary. Generally speaking, where the number of ligands is equal to the charge of the metal ions, the charge of the molecule is typically net neutral because the carboxy moieties of the ligands having formula (II) are in deprotonated form. By way of further example, in a chelate species where the metal ion carries a charge of 2+ and the ligand to metal ion ratio is 2:1, each of the hydroxyl or amino groups (i.e., R⁷ of compound II) is believed to be bound by a coordinate covalent bond to the metal while an ionic bond exists between each of the carboxylate groups of the metal ion. This situation exists, for example, where divalent zinc, copper, or manganese is complexed with two HMTBA ligands. By way of further example, where the number of ligands exceeds the charge on the metal ion, such as in a 3:1 chelate of a divalent metal ion, the ligands in excess of the charge generally remain in a protonated state to balance the charge. Conversely, where the positive charge on the metal ion exceeds the number of ligands, the charge may be balanced by the presence of another anion, such as, for example, chloride, bromide, iodide, bicarbonate, hydrogen sulfate, and dihydrogen phosphate.

Generally speaking, a suitable ratio of ligand to metal ion is from about 1:1 to about 3:1 or higher. In another embodiment, the ratio of ligand to metal ion is from about 1.5:1 to about 2.5:1. Of course within a given mixture of metal chelate compounds, the mixture will include compounds having different ratios of ligand to metal ion. For example, a composition of metal chelate compounds may have species with ratios of ligand to metal ion that include 1:1, 1.5:1, 2:1, 2.5:1, and 3:1.

Metal chelate compounds of the invention may be made in accordance with methods generally known in the art, such as described in U.S. Pat. Nos. 4,335,257 and 4,579,962, which are both hereby incorporated by reference in their entirety. In a preferred process for the preparation of metal chelate compounds, a metal source compound, such as a metal oxide, a metal carbonate, or a metal hydroxide is charged to a reaction vessel, and an aqueous solution of HMTBA is added to the source compound. The concentration of HMTBA in the aqueous solution is typically about 40% to about 89% by weight. The reaction typically proceeds for a period of two hours under moderate agitation. Depending on the starting material used in the reaction, typically water and/or carbon dioxide are produced. Ordinarily, the reaction may be conducted at atmospheric pressure, and the reaction mass is heated to a temperature ranging from about 90° C. to about 130° C. After the reaction is substantially complete, heating of the reaction mass is continued in the reaction vessel to produce a substantially dried product. Typically, the free water content is reduced to about 2% by weight, and the product mass transitions to free-flowing particulate solid. The dried metal chelate product may optionally be mixed with a calcium bentonite filer and ground to a powder. Alternatively, the metal chelate compounds may be purchased from a commercially available source. For example, HMTBA-Zn and HMTBA-Cu may be purchased from Novus International, Saint Louis, Mo., sold under the trade names MINTREX® Zn, and MINTREX® Cu, respectively.

In an alternative exemplary embodiment, the hydroxy analog of methionine may be a metal salt comprising an anionic compound having formula (II) together with a metal ion. Typically, suitable metal ions will have either a 1⁺, 2⁺ or 3⁺ charge and will be selected from zinc ions, copper ions, manganese ions, iron ions, chromium ions, silver ions, cobalt ions, and silver ions. Without being bound by any particular theory, however, it is generally believed that combinations of zinc, copper, manganese, iron, chromium, nickel, and cobalt ions together with HMTBA form metal chelates as opposed to salts. Irrespective or whether the molecule formed is a salt or a chelate, both forms of the molecules are included within the scope of the invention. Salts useful in the invention may be formed when the metal, metal oxide, metal hydroxide or metal salt (e.g., metal carbonate, metal nitrate, or metal halide) react with one or more compounds having formula (II). In an exemplary embodiment, the compound having formula (II) will be HMTBA.

Salts may be prepared according to methods generally known in the art. For example, a metal salt may be formed by contacting HMTBA with a metal ion source. In one embodiment, a silver ion having a 1+charge may be contacted with HMTBA to form a silver 2-hydroxy-4-methylthiobutanoate metal salt. This salt generally will have silver to HMTBA ratio of approximately 1:1.

(c) Antioxidants

The wood preservation compositions of the invention optionally may include an antioxidant other than the quinoline compounds having formula (I) (i.e., detailed in (a) above). In certain embodiments, the antioxidant may also have antimicrobial activity. In an exemplary embodiment, the antioxidant, when combined with a compound having formula (I), formula (II), or both, may act synergistically to enhance the anti-microbial effect of the combined blend of compounds compared to the antimicrobial activity of any single compound acting alone.

A variety of antioxidants are suitable for use in the wood preservative composition of the invention. For example, suitable classes of antioxidant compounds include sulfites, hydrosulfides, hydrazines, thiosemicarbazides, trialkyl phosphites, mixed alkyl/aryl phosphites, alkylated aryl phosphites, sterically hindered aryl phosphites, aliphatic spirocyclic phosphites, sterically hindered phenyl spirocyclics, sterically hindered bisphosphonites, hydroxyphenyl propionates, hydroxy benzyls, alkylidene bisphenols, alkyl phenols, aromatic amines, thioethers, hindered amines, hydroquinones and mixtures thereof.

In additional embodiments, other suitable antioxidants may be, for example, a phenolic antioxidant such as 4,4′-thiobis-6-t-butylmethylphenol, butylated hydroxyanisole (mixture of 2-t-butyl-4-methoxyphenol and 3-t-butyl-4-methoxyphenol), p-octyl phenol, mono (di or tri)-(.alpha.-methylbenzyl)phenol, 2,6-di-t-butyl-p-cresol (BHT) and pentaerythrithyl tetrakis [3-(3,5-di-t-butyl-4-hydroxyphenyl)]propionate; an amine-based antioxidant such as N,N′-di-2-naphthyl-p-phenylene diamine; a hydroquinoline-based antioxidant such as 2,5-di(t-amyl)hydroquinoline; a sulfur-based antioxidant such as dilauryl thiodipropionate; a phosphorus-based antioxidant such as triphenyl phosphite and 3,5-di-tert-butyl-hydroxycinnamate (known as IRGANOX 1076, commercially available from Ciba Geigy).

In still another embodiment, the antioxidant may be a tocopherol. Suitable forms of tocopherals include, alpha-, beta-, gamma- or delta-tocopherol, and its esters, especially vitamin E (tocopherol acetate), tocopheryl succinate, tocopherylnicotinate or tocopherylpoly(oxyethylene)-succinate. Another suitable tocopheral is the desmethyl tocopherols detailed in U.S. Pat. No. 6,346,544, which is hereby incorporated by reference in its entirety. In another alternative of this embodiment, the antioxidant may be ascorbic acid, TBHQ, ascobylpamitate, dilauryl thiodipropionate, stearyl citrate, octyl gallate, alpha lipolic, and propyl gallate.

In another embodiment, the antioxidant may be a hindered phenolic compound having formula (III):

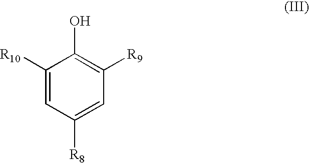

wherein
R₈, R₉, and R₁₀ are independently selected from hydrogen, halogen, methoxy, a C₍₂₋₁₂₎ alkoxy, or a C₍₁₋₁₂₎ alkyl group.

In an exemplary embodiment for compounds having formula (III), R₈ is methoxy or methyl, and R₉ and R₁₀ are both tert-butyl (butylated hydroxy toluene (BHT) or butylated hydroxy anisole (BHA)); and the phenol wherein R₈ is hydrogen and R₉ and R₁₀ are both tert-butyl.

For each embodiment for compounds having formula (III), the compounds may include dimers, trimers, or tetramers of the hindered phenols having the basic structure above, such as tetrakis[methylene(3,5-di-tert-butyl-4-hydroxy hydro-cinnamate)] or 4,4′-methylenebis(2,6-di-tert-butylphenol).

In a further embodiment, the antioxidant may be a polyphenols, which include flavonoids and other naturally occurring polyphenols. In one embodiment, the flavonoids may correspond to formula (IV):

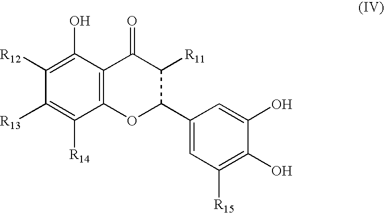

wherein
R₁₁, R₁₂, R₁₃, R₁₄, and R₁₅ are independently selected from hydrogen, hydroxyl, or a C₍₁₋₁₂₎ alkoxy group; and
wherein the dashed line represents a single or a double bond.

An exemplary flavonoid includes compounds wherein R₁₁ and R₁₃ are both hydroxyl and R₁₂, R₁₄, and R₁₅ are all hydrogen, and wherein the dashed line signifies a double bond (quercetin). Examples of the preferred flavonoids are chrysin, luteolin, myrcetin, hespertin and rhamnetin.

In another embodiment, the compound may be a naturally occurring polyphenol. The naturally occurring polyphenols are those derived from woody plants. These antioxidants include, but are not limited to, tannins (or their isolated derivatives) and lignins (or their isolated derivatives), for example, kraft pulping lignin, lignin sulfonates, organosolve lignin, autohydrolysis lignin, acid-hydrolyzed lignin, and steam-exploded lignin. Tannins include quebracho, chestnuts, wattle, Pinus spp. bark condensed tannins, and the ellagitannins of chestnuts, oaks, and eucalyptus. Examples of the preferred tannins and their derivatives are quebracho, wattle, Pinus spp. bark condensed tannins, chestnuts and oaks. Examples of the preferred lignins and their derivatives are kraft, lignin sulfonates and organosolve lignin.

(d) Formulations of Active Compounds

A variety of formulations of active compounds are suitable for use in the invention. In certain embodiments, the active compound may comprise a compound having formula (I). In other embodiments, the active compound may comprise a metal chelate or metal salt of a compound having formula (II). In certain embodiments, the active compounds may include a blend of any of the compounds having formula (I) in combination with any of the metal chelates or metal salts of compounds having formula (II). In each embodiment, the wood preservation composition may comprise an antioxidant, such as any of the antioxidants detailed in (c) above or otherwise known in the art. Several suitable blends of active compounds are detailed in Table A (i.e., the active compound(s), if any, of the column labeled compound 1 are combined with the active compound(s), if any, of the column labeled compound 2 to form a blend of active compounds).

TABLE A

| Compound No. 1 | Compound No. 2 |
|---|---|
| A compound having formula (I) | No other compound |
| A compound having formula (I) | A compound having formula (II) |
| A compound having formula (I) | HMTBA-Zn |
| A compound having formula (I) | HMTBA-Cu |
| A compound having formula (I) | HMTBA-Cr |
| A compound having formula (I) | BHT |
| A compound having formula (I) | A tocopheral |
| A compound having formula (I) | Ascorbic acid |
| A compound having formula (I) | A hindered phenolic compound having |
| | formula (III) |
| A compound having formula (I) | A polyphenol |
| A compound having formula (I) | A flavonoid |
| A compound having formula (I) | BHA |
| Ethoxyquin | HMTBA-Zn |
| Ethoxyquin | HMTBA-Cu |
| Ethoxyquin | HMTBA-Cr |
| Ethoxyquin | No other compound |
| Ethoxyquin | BHT |
| Ethoxyquin | A tocopheral |
| Ethoxyquin | Ascorbic acid |
| Ethoxyquin | A hindered phenolic compound having |
| | formula (III) |
| Ethoxyquin | A polyphenol |
| Ethoxyquin | A flavonoid |
| Ethoxyquin | BHA |
| HMTBA | No other compound |
| HMTBA | BHT |
| HMTBA | A tocopheral |
| HMTBA | A ascorbic acid |
| HMTBA | A hindered phenolic compound having |
| | formula (III) |
| HMTBA | A polyphenol |
| HMTBA | A flavonoid |
| HMTBA | BHA |
| HMTBA-Zn | No other compound |
| HMTBA-Zn | BHT |
| HMTBA-Zn | A tocopheral |
| HMTBA-Zn | Ascorbic acid |
| HMTBA-Zn | A hindered phenolic compound having |
| | formula (III) |
| HMTBA-Zn | A polyphenol |
| HMTBA-Zn | A flavonoid |
| HMTBA-Zn | BHA |
| HMTBA-Cu | No other compound |
| HMTBA-Cu | BHT |
| HMTBA-Cu | A tocopheral |
| HMTBA-Cu | Ascorbic acid |
| HMTBA-Cu | A hindered phenolic compound having |
| | formula (III) |
| HMTBA-Cu | A polyphenol |
| HMTBA-Cu | A flavonoid |
| HMTBA-Cu | BHA |
| HMTBA-Cr | No other compound |
| HMTBA-Cr | BHT |
| HMTBA-Cr | A tocopheral |
| HMTBA-Cr | Ascorbic acid |
| HMTBA-Cr | A hindered phenolic compound having |
| | formula (III) |
| HMTBA-Cr | A polyphenol |
| HMTBA-Cr | A flavonoid |
| HMTBA-Cr | BHA |
| Ethyoxquin and HMTBA-Cu | BHT |
| Ethyoxquin and HMTBA-Cu | A tocopheral |
| Ethyoxquin and HMTBA-Cu | Ascorbic acid |
| Ethyoxquin and HMTBA-Cu | A hindered phenolic compound having |
| | formula (III) |
| Ethyoxquin and HMTBA-Cu | A polyphenol |
| Ethyoxquin and HMTBA-Cu | A flavonoid |
| Ethyoxquin and HMTBA-Cu | BHA |

In one exemplary embodiment, the wood preservation composition will have 6-ethoxy-1,2-dihydro-2,2,4-trimethylquinoline. By way of example, the formulation may have a concentration of from about 0.1% to about 99% by weight 6-ethoxy-1,2-dihydro-2,2,4-trimethylquinoline. In a more typical embodiment, the formulation may have a concentration of from about 0.1% to about 50% by weight 6-ethoxy-1,2-dihydro-2,2,4-trimethylquinoline. In another embodiment, the formulation may have a concentration of from about 0.1% to about 40% by weight 6-ethoxy-1,2-dihydro-2,2,4-trimethylquinoline. In a further embodiment, the formulation may have a concentration of from about 0.1% to about 30% by weight 6-ethoxy-1,2-dihydro-2,2,4-trimethylquinoline. In another embodiment, the formulation may have a concentration of from about 0.1% to about 20% by weight 6-ethoxy-1,2-dihydro-2,2,4-trimethylquinoline. In yet another embodiment, the formulation may have a concentration of from about 0.1% to about 10% by weight of 6-ethoxy-1,2-dihydro-2,2,4-trimethylquinoline. In still another embodiment, the formulation may have a concentration from about 0.1% to about 5% by weight 6-ethoxy-1,2-dihydro-2,2,4-trimethylquinoline.

In another exemplary embodiment, the formulation will include 6-ethoxy-1,2-dihydro-2,2,4-trimethylquinoline and copper bis(2-hydroxy-4-methylthio)butanoic acid. As will be appreciated by a skilled artisan, the concentration of active compounds in a given formulation can and will vary depending upon the type of wood being treated, the method of applying the composition to the wood, and the microbial target. By way of example, the ratio of copper bis(2-hydroxy-4-methylthio)butanoic acid to 6-ethoxy-1,2-dihydro-2,2,4-trimethylquinoline present in the composition may range from about 1:50 to about 50:1 by weight. In another embodiment, the ratio of copper bis(2-hydroxy-4-methylthio)butanoic acid to 6-ethoxy-1,2-dihydro-2,2,4-trimethylquinoline present in the composition may range from about 1:50 to about 1:1 by weight. In yet another embodiment, the ratio of copper bis(2-hydroxy-4-methylthio)butanoic acid to 6-ethoxy-1,2-dihydro-2,2,4-trimethylquinoline present in the composition may range from about 1:50 to about 1:5 by weight. In still another embodiment, the ratio of copper bis(2-hydroxy-4-methylthio)butanoic acid to 6-ethoxy-1,2-dihydro-2,2,4-trimethylquinoline present in the composition may range from about 1:50 to about 1:10. In yet another embodiment, the ratio of copper bis(2-hydroxy-4-methylthio)butanoic acid to 6-ethoxy-1,2-dihydro-2,2,4-trimethylquinoline present in the composition may range from about 1:25 to about 1:10 by weight. In still another embodiment, the ratio of the ratio of copper bis(2-hydroxy-4-methylthio)butanoic acid to 6-ethoxy-1,2-dihydro-2,2,4-trimethylquinoline present in the composition may range from about 1:20 to about 1:17 by weight. In a further embodiment, the ratio of copper bis(2-hydroxy-4-methylthio)butanoic acid to 6-ethoxy-1,2-dihydro-2,2,4-trimethylquinoline present in the composition is about 1:19 to about 1:18 by weight.

In another embodiment, the formulation may include one active compound that is a metal chelate or metal salt of a compound having formula (II). In an exemplary embodiment, the compound is copper bis(2-hydroxy-4-methylthio)butanoic acid. By way of example, the formulation may have a concentration of from about 0.1% to about 99% by weight copper bis(2-hydroxy-4-methylthio)butanoic acid. In a more typical embodiment, the formulation may have a concentration of from about 0.1% to about 50% by weight copper bis(2-hydroxy-4-methylthio)butanoic acid. In another embodiment, the formulation may have a concentration of from about 0.1% to about 40% by weight copper bis(2-hydroxy-4-methylthio)butanoic acid. In a further embodiment, the formulation may have a concentration of from about 0.1% to about 30% by weight copper bis(2-hydroxy-4-methylthio)butanoic acid. In another embodiment, the formulation may have a concentration of from about 0.1% to about 20% by weight copper bis(2-hydroxy-4-methylthio)butanoic acid. In yet another embodiment, the formulation may have a concentration of from about 0.1% to about 10% by weight of copper bis(2-hydroxy-4-methylthio)butanoic acid. In still another embodiment, the formulation may have a concentration from about 0.1% to about 5% by weight copper bis(2-hydroxy-4-methylthio)butanoic acid.

(e) Waterborne Wood Preservatives and Oil borne Wood Preservatives

The wood preservation composition of the invention may be formulated into a variety of suitable forms, such as a liquid, a one-phase homogeneous system, emulsion, a slurry or as a dry material according to methods generally known in the art. Typically, the active ingredients will be mixed with a suitable carrier. The carrier may be an aqueous solvent to form a waterborne wood preservative. Alternatively, the carrier may be a non-aqueous solvent to form an oil borne wood preservative. As will be appreciated by a skilled artisan, the choice between aqueous and non aqueous solvents can and will be dictated by the degree of solubility of the active compounds in water and by the intended use for the wood preservative. By way of example, in an exemplary embodiment, copper bis(2-hydroxy-4-methylthio)butanoic acid, which is sparingly soluble in water, is combined with ethanolamine in water to form a waterborne wood preservative. By way of further example, the blend of copper bis(2-hydroxy-4-methylthio)butanoic acid and 6-ethoxy-1,2-dihydro-2,2,4-trimethylquinoline is substantially insoluble in water, and as such, this blend is typically combined with a non aqueous solvent to form an oil borne wood preservative. One skilled in the art can readily determine the water solubility of a given active compound, or blend of active compounds, and select appropriate aqueous or non-aqueous carriers to form either a waterborne preservative or an oil borne preservative.

A variety of aqueous carriers are suitable for use in the invention to form waterborne wood preservatives. The aqueous carrier is generally a solvent. Suitable aqueous solvents include both polar organic solvents, water, and mixtures of the foregoing, depending on the process used to apply the wood preservative formulation and the active agent or combination of agents used. Polar organic solvents useful in the invention, for example, include those that contain hydroxy, ether, keto, or ester groups. Embodiments of the invention may include polar solvents that are alcohols, glycols, glycoether diacetone alcohol, water-insoluble polyols, and their esters. In an exemplary embodiment, the solvent may be water or a water miscible solvent, or combinations thereof. Suitable water miscible solvents include, but are not limited to, alcohols, ammonias, glycols, esters, ethers, polyethers, amines, ketones, and any combination of any of the foregoing. In an exemplary embodiment, the water miscible solvent is an amine. Suitable amine based water miscible solvents include monoethanolamine (known as ethanolamine), monomethyl ethanolamine, isopropanolamine, diethanolamine, diglycolamine, 2-[(2-aminoethyl)-(2-hydroxyethyl)-amino]-ethanol, triethanolamine, N-aminoethyl-N′-hydroxyethyl-ethylenediamine, N,N′-dihydroxyethyl-ethylenediamine, 2-[2-(2-aminoethoxy)-ethylamino]-ethanol, 2-[2-(2-aminoethylamino)-ethoxy]-ethanol, 2-[2-(2-aminoethoxy)-ethoxy]-ethanol, tertiarybutyldiethanolamine, diisopropanolamine, n-propanolamine, isobutanolamine, 2-(2-aminoethoxy)-propanol, 1-hydroxy-2-aminobenzene, ethylenediamine, ethylenediamine diformic acid, and ethylenediaminetetraformic acid. In an exemplary embodiment, as detailed in the examples, the amine is ethanolamine. For each embodiment, to increase or improve the solubility of the active agents in the aqueous carrier, emulsifiers or solubilizers may be employed. Suitable examples of each of the foregoing agents are detailed below.

A variety of non-aqueous solvents are suitable for use in the invention to form oil borne wood preservatives. The non-aqueous solvent is generally an oil volatile or semi-volatile solvent or hydrophobic carrier. In one embodiment, the solvent is an oil volatile solvent. Generally speaking, volatile oil solvents are typically non-polar solvents (i.e., have low dipole moments and small dielectric constants) that are miscible in an oil-based mixture and have low boiling points (e.g., in the range of 120-200° C.) such that the solvent readily evaporates from the oil-based mixture. Suitable examples of volatile oil solvents include special gasolines, white spirits, methanol, ethanol, 1-propanol, 1-butanol, acetone, ethyl acetate, diethyl ether, methylene chloride, carbon tetrachloride, hexane, heptane, benzene, toluene, and xylene. In an additional embodiment, the non-aqueous solvent is a semi-volatile solvent. Semi-volatile solvents generally are compounds with boiling points greater than about 200° C. Examples of non-polar semi-volatile solvents include dibutyl phthalate, diethylene glycol monoethyl ether, 2-(2-n-butoxyethoxy)ethanol, triethylene glycol dimethyl ether, n-hexyl ether, diethylene glycol dibutyl ether, kerosene, and halogenated compounds. In an additional embodiment, the non-aqueous solvent may be a petroleum solvent (i.e., having a boiling point from about 250° C. to about 400° C.) such as petrolatum, petroleum distillates, spindle oil, liquid paraffin, middle distillates, white spirits, and a methylvinyl siloxane polymer.

The wood preservation composition optionally may include a dispersing agent or a stabilizing agent. Exemplary dispersing/stabilizing agents Exemplary suitable stabilizing agents include polyolefins such as polyallene, polybutadiene, polyisoprene, poly(substituted butadienes) such as poly(2-t-butyl-1,3-butadiene), poly(2-chlorobutadiene), poly(2-chloromethyl butadiene), polyphenylacetylene, polyethylene, chlorinated polyethylene, polypropylene, polybutene, polyisobutene, polybutylene oxides, copolymers of polybutylene oxides with propylene oxide or ethylene oxide, polycyclopentylethylene, polycyclolhexylethylene-, polyacrylates including polyalkylacrylates and polyarylacrylates, polymethacrylates including polyalkylmethacrylates and polyarylmethacrylates, polydisubstituted esters such as poly(di-n-butylitaconate), poly(amylfumarate), polyvinylethers such as poly(butoxyethylene) and poly(benzyloxyethylene), poly(methyl isopropenyl ketone), polyvinyl chloride, polyvinyl acetate, polyvinyl carboxylate esters such as polyvinyl propionate, polyvinyl butyrate, polyvinyl caprylate, polyvinyl laurate, polyvinyl stearate, polyvinyl benzoate, polystyrene, poly-t-butyl styrene, poly (substituted styrene), poly(biphenyl ethylene), poly(1,3-cyclohexadiene), polycyclopentadiene, polyoxypropylene, polyoxytetramethylene, polycarbonates such as poly(oxycarbonyloxyhexamethylene), polysiloxanes, in particular, polydimethyl cyclosiloxanes and organo-soluble substituted polydimethyl siloxanes such as alkyl, alkoxy, or ester substituted polydimethylsiloxanes, liquid polysulfides, natural rubber and hydrochlorinated rubber, ethyl-, butyl- and benzyl-celluloses, cellulose esters such as cellulose tributyrate, cellulose tricaprylate, and cellulose tristearate, natural resins such as colophony, copal, and shellac, and the like, and combinations or copolymers thereof.

The wood preservation composition may optionally contain one or more additives to aid wetting, for example surfactants. Examples of suitable classes of surface active agents (dispersants) include anionics such as alkali metal fatty acid salts, including alkali metal oleates and stearates; alkali metal lauryl sulfates; alkali metal salts of diisooctyl sulfosuccinate; alkyl aryl sulfates or sulfonates, lignosulfonates, alkali metal alkylbenzene sulfonates such as dodecylbenzene sulfonate, alkali metal soaps, oil-soluble (e.g., calcium, ammonium, etc.) salts of alkyl aryl sulfonic acids, oil soluble salts of sulfated polyglycol ethers, salts of the ethers of sulfosuccinic acid, and half esters thereof with nonionic surfactants and appropriate salts of phosphated polyglycol ethers; cationics such as long chain alkyl quaternary ammonium surfactants including cetyl trimethyl ammonium bromide, as well as fatty amines; nonionics such as ethoxylated derivatives of fatty alcohols, alkyl phenols, polyalkylene glycol ethers and condensation products of alkyl phenols, amines, fatty acids, fatty esters, mono-, di-, or triglycerides, various block copolymeric surfactants derived from alkylene oxides such as ethylene oxide/propylene oxide (e.g., PLURONIC®, which is a class of nonionic PEO-PPO co-polymer surfactant commercially available from BASF), aliphatic amines or fatty acids with ethylene oxides and/or propylene oxides such as the ethoxylated alkyl phenols or ethoxylated aryl or polyaryl phenols, cellulose derivatives such as hydroxymethyl cellulose (including those commercially available from Dow Chemical Company as METHOCEL®), and acrylic acid graft copolymers; zwitterionics; tristyryl ethoxylated phosphoric acid or salts, methyl vinyl ether-maleic acid half-ester (at least partially neutralized), beeswax, water soluble polyacrylates with at least 10% acrylic acids/salts; alkyl grafted PVP copolymers commercially available as GANEX®. and/or the AGRIMER®. AL or WP series, PVP-vinyl acetate copolymers commercially available as the AGRIMER® VA series, lignin sulfonate commercially available as REAX 85A (e.g., with a molecular weight of about 10,000), tristyryl phenyl ethoxylated phosphoric acid/salt commercially available as SOPROPHOR®.TM. 3D33, GEROPON® SS 075, calcium dodecylbenzene sulfonate commercially available as NINATE® 401 A, IGEPAL®. CO 630, other oligomeric/polymeric sulfonated surfactants, and the like.

(f) Formulations with Other Agents

The wood preservative compositions of the invention may be combined with other fungicides. Generally speaking, fungicides as a group exhibit a diverse variety of modes of action. Exemplary combinations of fungicides include those in which the combined fungicides have different and complementary modes of actions. These modes of action, for example, include functions such as uncouplers, kinase inhibitors, metal chelators, or those that impact metabolic activities of the fungi. As such, a fungicide that functions as an uncoupler may synergistically be combined with a fungicide that is a kinase inhibitor. Alternatively, a fungicide that is a metabolic disruptor may be synergistically combined with a fungicide that is a kinase inhibitor. A skill artisan can readily formulate combinations of two or more fungicides having different modes of action in order to achieve such a synergistic effect.

Exemplary fungicides suitable for use in the invention include, without limitation, azoles; triazoles; imidazoles; pyrimidinyl carbinoles; 2-aminopyrimidines; morpholines; pyrroles; phenylamides; benzimidazoles; carbamates; dicarboximides; carboxamides; dithiocarbamates; dialkyldithiocarbamates; N-halomethylthio-dicarboximides; pyrrole carboxamides; oxine-copper, guanidines; strobilurines; nitrophenol derivatives; organo phosphorous derivatives; polyoxins; pyrrolethioamides; phosphonium compounds; polymeric quaternary ammonium borates; succinate dehydrogenase inhibitors; formaldehyde-releasing compounds; naphthalene derivatives; sulfenamides; aldehydes; quaternary ammonium compounds; amine oxides, nitroso-amines, phenol derivatives; organo-iodine derivatives; nitrites; quinolines such as 8-hydroxyquinoline including their Cu salts; phosphoric esters; organosilicon compounds; pyrethroids; nitroimines and nitromethylenes; and mixtures thereof.

In a further embodiment, the wood preservation compositions may optionally include one or more compounds to protect the wood or wood product from bacterial degradation or attack. Suitable bacteriocides include, for example, 3-isothiazolones, 3-iodo-2-propynylbutylcarbamate, 1,2-dibromo-2,4-dicyanobutane, methylene-bis-thio-cyanate (MBT), 2-thiocyano-methylthiobenzothiazole, tetrachloroisophthalo-nitrile, 5-bromo-5-nitro-1,3-dioxane, 2-bromo-2-nitropropane-1,3-diol, 2,2-di-bromo-3-nitrilopropionamide (DBNPA), N,N′-dimethylhydroxyl-5,5′-dimethyl-hydantoin, bromochlorodimethylhydantoin, 1,2-benzisothiazolin-3-one, 4,5-tri-methylene-2-methyl-3-isothiazolone, 5-chloro-2-(2,4-dichlorophenoxy)-phenol, 3,4,4′-trichlorocarbanilide, copper naphthenate, copper-8-hydroxy-quinoline, zinc borate, boric acid, trimethyl boron, zinc oxide, glutaraldehyde, 1,4-bis(bromo-acetoxy)-2-butene, 4,5-dichloro-1,1-dithiacyclopentene-3-one, chlorothalonil and quaternary ammonium based compounds.

The wood preservation compositions may optionally include one or more compounds to protect the wood or wood product from insect deterioration or attack. In an exemplary embodiment, the insecticide will protect the wood or wood product from termites. Suitable non-limiting examples of insecticides include, for example, acephate, aldicarb, alpha-cypermethrin, azinphos-methyl, bifenthrin, binapacryl, buprofezin, carbaryl, carbofuran, cartap, chlorpyrifos, chlorpyrifos methyl, clofentezine, cyfluthrin, cyhexatin, cypermethrin, cyphenothrin, deltamethrin, demeton, demeton-S-methyl, demeton-O-methyl, demeton-S, demeton-S-methyl sulfoxid, demephion-O, demephion-S, dialifor, diazinon, dicofol, dicrotophos, diflubenzuron, dimethoate, dinocap, endosulfan, endothion, esfenvalerate, ethiofencarb, ethion, ethoate-methyl, ethoprop, etrimfos, fenamiphos, fenazaflor, fenbutatin-oxide, fenitrothion, fenoxycarb, fensulfothion, fenthion, fenvalerate, flucycloxuron, flufenoxuron, fluvalinate, fonofos, fosmethilan, furathiocarb, hexythiazox, isazophos, isofenphos, isoxathion, methamidophos, methidathion, methiocarb, methomyl, methyl parathion, mevinphos, mexacarbate, monocrotophos, nicotine, omethoate, oxamyl, parathion, permethrin, phorate, phosalone, phosmet, phosphamidon, pirimicarb, pirimiphos-ethyl, profenofos, promecarb, propargite, pyridaben, resmethrin, rotenone, tebufenozide, temephos, TEPP, terbufos, thiodicarb, tolclofos-methyl, triazamate, triazophos and vamidothion.

Other additives that confer desirable characteristics on wood and wood products are also within the scope of this invention. Suitable additives include fixing agents, softeners, emulsifiers, cross-linking agents, solution mediators, pigments, dyes, anti-corrosion agents, odor correctors, pH-regulators, UV-stabilizers, waxes and drying oils, water repellants, colorants, and fire retarding chemicals. For example, suitable fire retarding chemicals, include chemicals such as borax/boric acid, guanylurea phosphate-boric acid, dicyandiamide phosphoric acid formaldehyde and diethyl-N,N-bis(2-hydroxyethyl)aminomethyl phosphate.

II. Methods for Contacting Wood Compositions with Wood

Another aspect of the invention encompasses methods for treating wood or a wood product with a wood preservative composition of the invention in order to confer resistance to microbes, including but not limited to fungi and bacteria. An additional aspect of the invention includes the wood or wood product treated with the wood preservation composition. In some embodiments, the wood preservative composition may be disposed on the surface of wood or a wood product. In other embodiments, the wood preservative composition may be impregnated into the wood or wood product. Alternatively, the wood preservation composition may be infused into the interstices of the wood or wood product.

The wood preservative compositions of the invention may be incorporated into the wood or wood product by treatment methods that involve contact of the wood with aqueous or non aqueous (i.e., depending on the embodiment) solutions, emulsions or suspensions of any of the aforementioned active agents of the invention. The delivery system may be a multiphase system or it may be a one-phase homogeneous system. In an exemplary, the wood may be contacted with a one-phase homogeneous system. As used herein a “homogeneous system” is typically a system having only one phase present in the system. The phase of the homogeneous system may be aqueous or the phase of the homogeneous system may be non-polar, organic, or oil-based. In certain embodiments, chemical solvents may be needed to optimize a uniform or homogenous one-phase system. Similarly, physical means, such as vigorous shaking or sonication, may be needed to optimize a uniform or homogenous one-phase system.

Irrespective of the particular system, i.e., multiphase or one phase, suitable methods of contacting the wood preservative with the wood include, for example, brushing, spraying, painting, atomizing, dipping, pressure and other similar treatments. With respect to wood products such as particleboard or plywood, the wood preservation composition may also be introduced in a glue-mixing process. In an exemplary embodiment, application of the wood preservation composition to wood or wood products is by pressure treatment in a suitable container, such as a cylinder, using two or more atmospheres of pressure.

The soaking of wood and wood products may be done at standard pressure, by use of vacuum-pressure cycles, pressure or other standard wood preservation processes. Use of vacuum-pressure or pressure techniques reduces treatment time and increases the level of penetration of the wood preservation composition into the wood product, thereby increasing the effectiveness of the preservative treatment. Preferably the treatment is conducted by subjecting the impregnated wood material to a pressure treatment during contact of the wood material with the aqueous treatment solution for a sufficient time, preferably from about 5 minutes to about 72 hours.

In an exemplary application, the wood preservation composition may be impregnated into the wood by an injection process under pressure. Generally for this embodiment, the active compounds detailed above (e.g., copper bis(2-hydroxy-4-methylthio)butanoic acid) are formulated into an aqueous one-phase homogenous system, such as copper bis(2-hydroxy-4-methylthio)butanoic acid in an ethanolamine-water system. This wood preservation composition is then injected into wood. Typically, a vacuum is drawn on the wood prior to, and the wood preservation composition is either mixed with the wood material or fibers before bonding, or more preferably, injected into the wood material or fibers, followed by bonding. Heat may be applied. The vacuum generally removes a portion of the air in the wood, so that compressed air will not prevent the wood preservation composition from reaching the center of wood being treated. After contacting the wood preservation composition with the wood, the pressure is increased to between 20 psig and about 200 psig, typically around 100 psig. Generally the increase in pressure is controlled so as to make the process take several minutes.

Wood to be treated by the method of the present invention may have a moisture content varying from dry to green, that is, moisture contents ranging from less than 20% and up to 100%. Impregnation of the wood preservation composition, however, is generally more effective when done on dry wood, preferably with a moisture content of less than 20%.

### Definitions

As used herein, the terms “wood” and “wood material” shall mean all forms of wood, for example, solid wood (such as timber or lumber in the form of logs, beams, plants, sheets and boards), wood composite materials (such as wood fiber board, chip board, and particle board) and all products made from wood and wood-composite materials (such as mill frames, decking, siding, truss joists, foundation piers, pilings, flooring, siding, cladding, roof shingles and utility poles). The wood or wood material may be for either above ground applications or for below ground applications.

As various changes could be made in the above compounds, products and methods without departing from the scope of the invention, it is intended that all matter contained in the above description and in the examples given below, shall be interpreted as illustrative and not in a limiting sense.

### EXAMPLES

The following example illustrates the ability of the wood preservative compositions of the invention to substantially prevent soil block decay of southern pinewood.

The decay resistance of southern pine treated with six experimental wood preservative formulations and exposed to two brown rot fungal species were tested using the AWPA E10-01 “Standard Method of Testing Wood Preservatives by Laboratory Soil-Block Cultures.” For this, conditioned blocks of wood are treated with suitable solutions of preservative. After a conditioning period, the wood blocks are exposed to a recognized destructive species of wood-destroying fungi. The minimum amount of preservative that protects the wood blocks against decay by a given fungus is defined as the threshold retention for that organism. Failure to protect is evidenced by loss of mass from the treated wood blocks, as indicated by a loss of weight.

Preparation of wood. Southern pine sapwood (Pinus spp.) with 6-10 rings/inch and clear of knots or other obvious defects was used. The wood was milled into test blocks of 19 mm×19 mm×19 mm. The test cubes were divided into density groups of ±5%, with 5 blocks per treatment or control. One feeder strip is needed for each block in a culture bottle. The sapwood selected for feeder strips should be capable of furnishing a satisfactory growth of the test fungus. Southern pine sapwood feeder strips were cut to approximately 3 by 28 by 34 mm with the grain of the wood parallel to either of the long dimensions and with the edge grain (radial surface) exposed to the flat face, insofar as possible.

The test blocks were pressure treated with the test preservatives, solvent alone, or two control wood preservatives, ACQ-Type D and propiconazole (Tebuconazole) according to procedures detailed in AWPA Standard E7-01. Several of the compounds detailed in Table 1 are commercially available from Novus International, Saint Louis, Mo. (i.e., the composition abbreviated Biox AUSD is a blend of organic acid, inorganic acid and HMTBA and is sold under the trade name ACTIVATE® US WD; the compound abbreviated Biox C is HMBTA-Cu and is sold under the trade name MINTREX® Cu; the compound Biox C/Biox SE is a blend of ethoxyquin and HMTBA-Cu; the compound abbreviated Biox SE is ethoxyquin emulsion; the compound abbreviated Biox T is an antioxidant blend sold under the trade name TOXGUARD®, and the compound abbreviated Biox Z is HMTBA-Zn is sold under the trade name MINTREX® Zn).

Briefly, a full cell pressure process, simulating commercial practice as far as possible with laboratory plant equipment, using an initial vacuum, suitable temperature, and an appropriate pressure period was used. The amount of preservative absorbed by the block, i.e., the retention, was calculated for each preservative. Table 1 lists the tested preservatives, solvents used, and the retention combinations (kg/m³). After the test blocks were treated and weighed to obtain absorption, they were exposed to open laboratory conditions until the solvent evaporated and the moisture content was relatively stable. Then they were placed in a conditioning room for 21 days. The blocks were tested in the unleached condition.

TABLE 1
Specimen types (numbers) and preservation/retention combinations.

| | | Preservative Retention (kg/m³) | | | | | | | |
|---|---|---|---|---|---|---|---|---|---|
| | | | | | | Biox | | | |
| | | | | Biox | Biox | C/Biox | | ACQ- | |
| No. | Solvent | Biox Z | Biox C | SE | AUSD | SE | Biox T | Type D | Tebuconazole |
| 1 | n/a | | | | | | | | |
| 2 | water | 0.05 | | | | | | | |
| 3 | | 0.10 | | | | | | | |
| 4 | | 0.50 | | | | | | | |
| 5 | | 2.00 | | | | | | | |
| 6 | water | | | | 0.05 | | | | |
| 7 | | | | | 0.10 | | | | |
| 8 | | | | | 0.50 | | | | |
| 9 | | | | | 2.00 | | | | |
| 10 | water | | | | | | 0.05 | | |
| 11 | | | | | | | 0.10 | | |
| 12 | | | | | | | 0.50 | | |
| 13 | | | | | | | 2.00 | | |
| 14 | 5% | | 0.05 | | | | | | |
| | ethanol- | | | | | | | | |
| | amine/ | | | | | | | | |
| | water | | | | | | | | |
| 15 | | | 0.10 | | | | | | |
| 16 | | | 0.50 | | | | | | |
| 17 | | | 2.00 | | | | | | |
| 18 | water | | | | | | | 0.05 | |
| 19 | | | | | | | | 0.10 | |
| 20 | | | | | | | | 0.50 | |
| 21 | | | | | | | | 2.00 | |
| 22 | toluene | | | 0.05 | | | | | |
| 23 | | | | 0.10 | | | | | |
| 24 | | | | 0.50 | | | | | |
| 25 | | | | 2.00 | | | | | |
| 26 | toluene | | | | | 0.05 | | | |
| 27 | | | | | | 0.10 | | | |
| 28 | | | | | | 0.50 | | | |
| 29 | | | | | | 2.00 | | | |
| 30 | toluene | | | | | | | | 0.010 |
| 31 | | | | | | | | | 0.025 |
| 32 | | | | | | | | | 0.050 |
| 33 | | | | | | | | | 0.100 |
| 34 | 5% | | | | | | | | |
| | ethanol- | | | | | | | | |
| | amine/ | | | | | | | | |
| | water | | | | | | | | |
| 35 | toluene | | | | | | | | |

Preparation of soil culture bottles. A soil substrate with a water holding capacity between 20% and 40% and a pH between 5.0 and 8.0 was used. The soil substrate, sifted and lightly compacted by tapping, was placed in 8-oz cylindrical culture bottles fitted with screw caps without liners. The bottles were about half-full. This amount of soil, about 118 ml for an 8-oz. culture bottle, weighed not less than 90 g when oven-dried. Water was added until it was about 130% of the water-holding capacity of the soil. The soil was leveled and one feeder strip per block was placed in each bottle. The soil-filled bottles were autoclaved for 30 min (one time), with the caps loosened. Lids on jars with a breather hole were covered with a strip of cloth first-aid tape.

Preparation of test cultures. Gloeophyllum trabeum (ATCC 11539), a fungus particularly tolerant to phenolic and arsenic compounds, and Postia placenta (Madison 698), a fungus particularly tolerant to copper and zinc compounds were grown in a sterile nutrient medium consisting of 2% (w) malt extract and 1.5% (w) agar. Sections (e.g., 10 mm squares) were cut from near the leading edge of mycelium in petri dish cultures and placed in contact with an edge of a feeder strip on the soil of the culture bottles. The bottles were incubated at the desired temperature until the feeder strips were covered by mycelium (approximately three weeks).

Decay testing Before the test blocks were placed in the culture bottles, they were sterilized. After cooling, the test blocks were aseptically placed with a cross-section face centered in contact with the mycelium-covered feeder strip in the previously prepared culture bottles. The culture bottles were incubated at 77-81° F. at 65-75% relative humidity for 12 weeks. At the end of the incubation period, the blocks were removed, the mycelium was carefully brushed off, and the blocks were weighed.

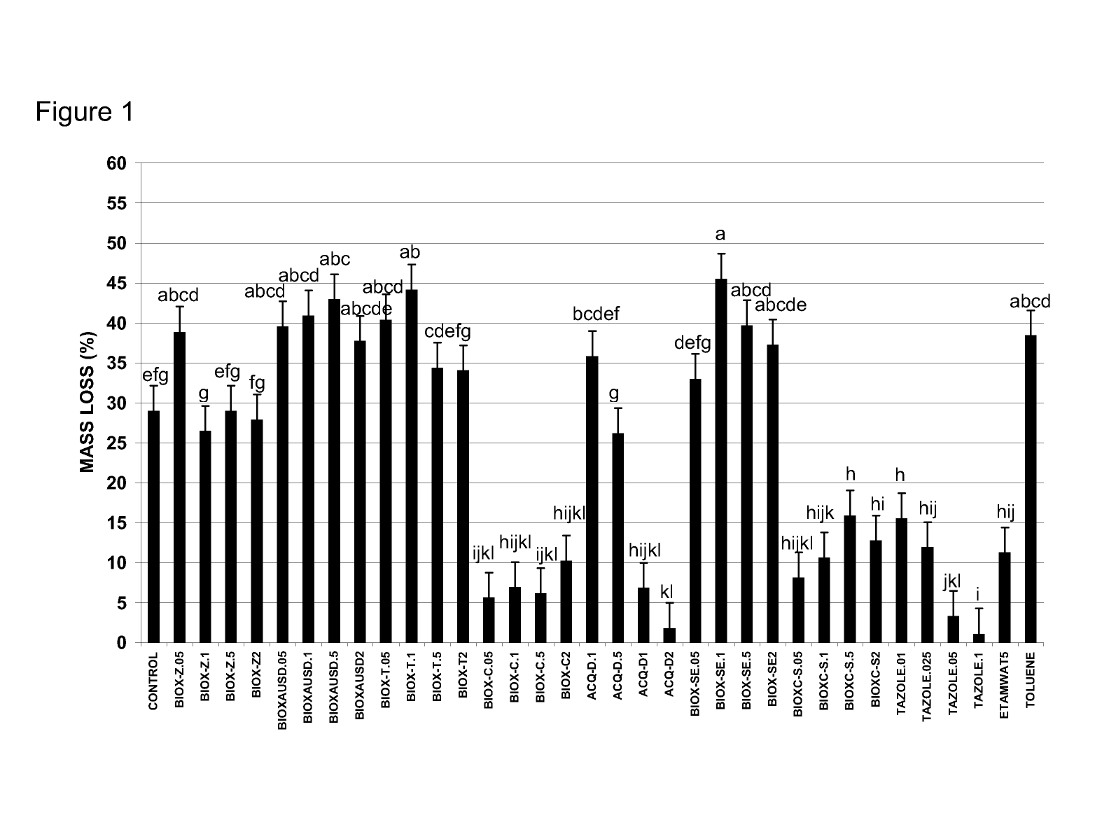

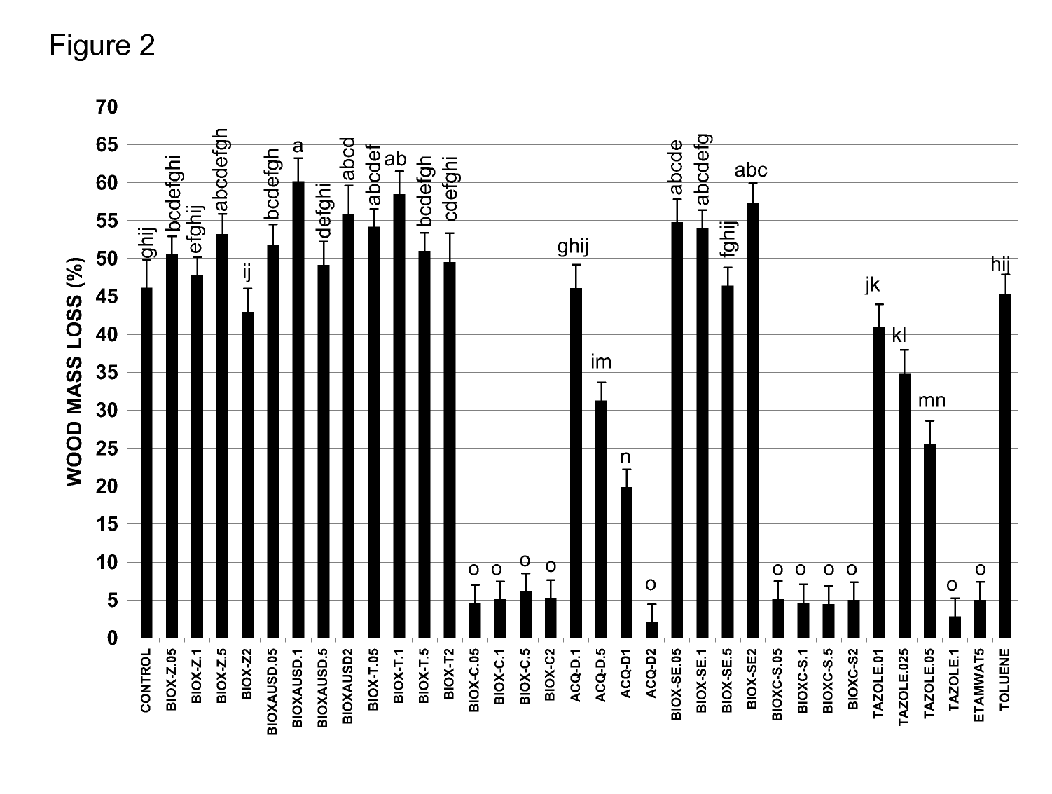

Results. Table 2 presents the mean percent weight losses and standard deviations for each set of blocks by wood treatment and fungus. The mean mass loss of wood exposed to G. trabeum is shown graphically in FIG. 1, and the mean mass loss of wood exposed to P. placenta is presented in FIG. 2.

TABLE 2
Mean percent weight loss of treatment sets by leach condition and fungus
exposure (n = 5; s.d. in parentheses).

| | | | | Unleached | |
|---|---|---|---|---|---|
| | | | | Brown Rot | |
| Specimen | | | Retention | G. | P. |
| Number | Solvent | Preservative | (kg/m³) | trabeum | placenta |
| 1 | Untreated | — | — | 28.9 (6.1) | 19.0 (24.7) |
| 2 | Water | Biox Z | 0.05 | 38.8 (3.3) | 50.4 (2.9) |
| 3 | | | 0.10 | 26.4 (8.5) | 47.7 (5.1) |
| 4 | | | 0.50 | 28.9 (15.2) | 42.6 (23.8) |
| 5 | | | 2.00 | 27.8 (6.1) | 26.1 (23.2) |
| 6 | Water | Biox AUSD | 0.05 | 39.5 (4.4) | 41.5 (23.6) |
| 7 | | | 0.10 | 40.8 (3.4) | 36.2 (32.9) |
| 8 | | | 0.50 | 42.9 (4.5) | 29.7 (29.0) |
| 9 | | | 2.00 | 37.7 (2.4) | 22.7 (30.2) |
| 10 | Water | Biox T | 0.05 | 40.3 (2.5) | 54.0 (11.3) |
| 11 | | | 0.10 | 44.1 (7.0) | 35.3 (31.7) |
| 12 | | | 0.50 | 34.3 (19.1) | 50.9 (8.3) |
| 13 | | | 2.00 | 34.0 (9.6) | 20.5 (26.5) |
| 14 | 5% Ethanolamine/ | Biox C | 0.05 | 5.5 (0.7) | 4.5 (0.8) |
| | Water | | | | |
| 15 | | | 0.10 | 6.9 (1.8) | 5.0 (1.0) |
| 16 | | | 0.50 | 6.1 (0.7) | 6.1 (0.4) |
| 17 | | | 2.00 | 10.2 (5.3) | 5.1 (0.7) |
| 18 | Water | ACQ-Type D | 0.10 | 35.7 (4.2) | 27.9 (25.2) |
| 19 | | | 0.50 | 26.1 (5.8) | 31.2 (10.5) |
| 20 | | | 1.00 | 6.8 (2.2) | 19.8 (5.4) |
| 21 | | | 2.00 | 1.7 (0.3) | 2.0 (0.5) |
| 22 | Toluene | Biox SE | 0.05 | 32.9 (18.4) | 33.1 (29.7) |
| 23 | | | 0.10 | 45.4 (5.5) | 53.8 (9.0) |
| 24 | | | 0.50 | 39.6 (6.5) | 46.3 (7.2) |
| 25 | | | 2.00 | 37.2 (8.1) | 45.9 (25.3) |
| 26 | Toluene | Biox C/Biox S* | 0.05 | 8.1 (7.5) | 5.0 (0.3) |
| 27 | | | 0.10 | 10.6 (5.1) | 4.6 (0.7) |
| 28 | | | 0.50 | 15.8 (7.4) | 4.4 (0.4) |
| 29 | | | 2.00 | 12.7 (5.9) | 4.9 (0.2) |
| 30 | Toluene | Tebuconazole | 0.010 | 15.5 (3.7) | 24.9 (21.8) |
| 31 | | | 0.025 | 11.8 (8.3) | 22.4 (17.4) |
| 32 | | | 0.050 | 3.2 (1.3) | 15.5 (13.6) |
| 33 | | | 0.100 | 1.0 (0.4) | 2.8 (3.1) |
| 34 | 5% Ethanolamine/ | — | — | 11.2 (6.4) | 4.9 (1.2) |
| | Water | | | | |
| 35 | Toluene | — | — | 38.4 (2.8) | 36.3 (20.4) |

*Mass ratio Biox C:Biox S = 1/18.6; retention target (kg/m³) based on Biox S.

The mean percent weight losses of untreated and toluene-only controls were generally high, confirming the virulence of the fungi to cause decay and to provide a rigorous test of the treatments. Variability of weight losses among blocks within replicate sets was presumably due to natural variability of fungal activity or uneven distribution of the fungicides incorporated into the wood blocks.

The ethanolamine retention in all of the Biox C treatments was 36 kg/m³. In contrast, the ethanolamine retention in the four ACQ retentions was 0.044, 0.22, 0.44, and 0.89 kg/m³. This is in the order of increasing ACQ retentions. Blocks treated with 36 kg/m³ ethanolamine itself have average weight losses of 11.2% (G. trabeum) or 4.9% (P. placenta). Blocks treated with BioxC/ethanolamine had weight losses of approximately 6.5% (G. trabeum) or 5.0% (P. placenta) with no observable dose response. The greater variability of the Postia data may be due to inconsistent initial colonization of some of the soil bottles. This fungus sometimes has difficulty colonizing the wood feeder strips in the bottles.

What is claimed is:

1. A waterborne wood preservation composition, the composition comprising an aqueous carrier and a metal chelate or a metal salt, the metal chelate or metal salt comprising metal ions and a hydroxy analog of methionine.

2. The composition of claim 1, wherein the metal ions are copper ions.

3. The composition of claim 1, wherein the hydroxyl analog of methionine is a compound having formula (II): 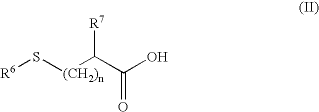
wherein:
n is an integer from 0 to 2;
R⁶ is methyl of ethyl; and
R⁷ is hydroxyl or amino.

4. The composition of claim 1, wherein the hydroxyl analog of methionine is 2-hydroxy-4(methylthio)butanoic acid.

5. The composition of claim 4, wherein the metal ions are copper ions.

6. The composition of claim 5, wherein copper bis(2-hydroxy-4-methylthio)butanoic acid is present in the composition at a concentration from about 0.1% to about 20% by weight.

7. The composition of claim 6, wherein the aqueous carrier is a solvent selected from the group consisting of water, a polar organic solvent, and a water-miscible solvent.

8. The composition of claim 7, wherein the composition further comprises an agent selected from the group consisting of emulsifier, surfactant, dispersants, binders, and fixative.

9. The composition of claim 8, wherein the composition further comprises an additional agent selected from the group consisting of an antioxidant, a fungicide, a bactericide, and an insecticide effective against termites.

10. The composition of claim 1, wherein the metal chelate or metal salt is copper bis(2-hydroxy-4-methylthio)butanoic acid and the aqueous carrier is an ethanolamine water solvent.

11. A method for inhibiting microbial deterioration of wood, the method comprising contacting the wood with a metal chelate or a metal salt, the metal chelate or metal salt comprising metal ions and a hydroxy analog of methionine.

12. The method of claim 11, wherein the metal ions are copper ions.

13. The method of claim 11, wherein the hydroxyl analog of methionine is a compound having formula (II): 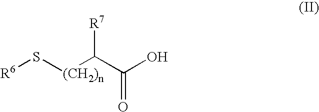
wherein:
n is an integer from 0 to 2;
R⁶ is methyl of ethyl; and
R⁷ is hydroxyl or amino.

14. The method of claim 11, wherein the hydroxyl analog of methionine is 2-hydroxy-4(methylthio)butanoic acid.

15. The method of claim 14, wherein the metal ions are copper ions.

16. The method of claim 15, wherein copper bis(2-hydroxy-4-methylthio)butanoic acid is present in the composition at a concentration from about 0.1% to about 20% by weight.

17. The method of claim 16, wherein the aqueous carrier is a solvent selected from the group consisting of water, a polar organic solvent, and a water-miscible solvent.

18. The method of claim 17, wherein the composition further comprises an agent selected from the group consisting of emulsifier, surfactant, dispersants, binders, and fixative.

19. The method of claim 18, wherein the composition further comprises an additional agent selected from the group consisting of an antioxidant, a fungicide, a bactericide, and an insecticide effective against termites.

20. The method of claim 11, wherein the metal chelate or metal salt is copper bis(2-hydroxy-4-methylthio)butanoic acid and the aqueous carrier is an ethanolamine water solvent.

21. The method of claim 11, wherein the composition is contacted with the wood by a treatment process selected from the group consisting of pressure treatment, soaking, dipping, brushing, and spraying.

22. A wood or wood-containing product, the wood or wood product having a metal chelate or metal salt of a hydroxy analog disposed on or within the wood or wood product.

23. The wood or wood-containing product of claim 22, wherein the metal chelate or metal salt is copper bis(2-hydroxy-4-methylthio)butanoic acid in an ethanolamine water solvent.
